(19) United States
(12) Patent Application Publication
(10) Pub. No.: US 2007/0178239 A1
(43) Pub. Date: Aug. 2, 2007

(54) Protective coating for painted or glossy surfaces

(75) Inventors: Howard A. Kestell, Burnsville, MN (US); Kim R. Smith, Woodbury, MN (US); Keith E. Olson, Apple Valley, MN (US)

Correspondence Address: Ann Kulprathipanja;KINNEY & LANGE, P.A., THE KINNEY & LANGE BUILDING, 312 South Third Street, Minneapolis, MN, 55415-1002, US

(73) Assignee: Ecolab Inc.

(21) Appl. No.: 11/345,443

(22) Filed: Feb. 1, 2006

(51) Int. Cl. B05D 3/02

(52) U.S. Cl. 427/393.4; 524/502

(57) ABSTRACT

A glossy protective coating for painted or glossy surfaces is formed from a substantially silicone-free aqueous emulsion of film-forming agent, solvent, and a fluoropolymer that reduces soil adhesion and increases water repellency.

### TECHNICAL FIELD

This invention relates to renewable protective coatings for painted or glossy surfaces such as are present on automobiles, trucks, boats, motorcycles, snowmobiles and other vehicles.

### BACKGROUND

The glossy painted or plastic exterior portions of automobiles and other vehicles often are coated with a hand-appliable, air-drying, buffable liquid or semisolid renewable product that protects the coated surface. These products are often described as “waxes” (e.g., “car waxes”) since in most instances they contain a wax. These products may also be called “glossy protective coatings”, and can be contrasted with “car polishes” which may contain a mild abrasive but typically do not include substantial amounts of a wax or other film former. References describing glossy protective coatings include U.S. Pat. Nos. 4,284,668, 4,525,501, 5,006,624, 5,017,222, 5,261,951, 5,330,787, 5,962,074, 6,193,791 B1, 6,235,824 B1, 6,669,763 B1, 6,746,522 B2, 6,932,860 B1 and 6,949,271 B2. Formulation information for a number of glossy protective coatings is listed in the Auto Products—Body—AutoWax/Paint Protectant category of the National Institutes of Health Household Products Database at http://householdproducts.nlm.nih.gov/products.htm.

### SUMMARY OF THE INVENTION

Nearly all glossy protective coatings contain silicones. A few glossy protective coatings are said to be silicone-free, including SIMONIZ™ Original Wax from Holt Lloyd International Ltd. and Silicone Free Polish from Travik Chemicals, but such silicone-free products are not as widely used as are silicone-containing glossy protective coatings. Silicones improve the water repellency of surfaces treated with the glossy protective coating, and typically will improve the extent to which water beads up on the treated surface. Consumers typically associate such beading behavior with a properly protected surface, and may associate the lack of such behavior with a surface that should be retreated.

We have found that silicones may also increase the tendency for dirt and other soils to adhere to the treated surface. The resulting soil film reduces the apparent surface gloss. Although most of the soil film may be removed by washing and drying the treated surface, washing is time-consuming and costly. We have also observed that repeated soiling and washing can cause an unrecoverable loss in gloss, and that when soiling does not take place between washes gloss does not significantly decrease. We prefer to reduce the extent to which soils adhere to the treated surface in the first instance. We have found that reduced soil pick-up and a desirable appearance after repeated soiling and washing can be obtained using a glossy protective coating that is free or substantially free of soil-attracting silicones and that contains a fluoropolymer that reduces soil adhesion on and increases water repellency of surfaces treated with the glossy protective coating. The present invention thus provides, in one aspect, a glossy protective coating composition comprising a substantially silicone-free aqueous emulsion of a film-forming agent, solvent, and a fluoropolymer that reduces soil adhesion on and increases water repellency of painted or glossy surfaces treated with the glossy protective coating.

The invention provides in another aspect a method for protecting a painted or glossy surface comprising applying to the surface and drying a substantially silicone-free aqueous emulsion of a film-forming agent, solvent, and a fluoropolymer that reduces soil adhesion on and increases water repellency of the surface.

### DETAILED DESCRIPTION

The word “silicone” refers to a polydiorganosiloxane wherein each organo group may be an alkyl group such as a C₁ to C₁₂ alkyl group. The phrase “substantially silicone-free” refers to a composition that contains a sufficiently low amount of silicone so that when The composition is compared to an otherwise similar control composition containing no silicone and evaluated using the kaolin clay particle retention test shown below in Example 1, a surface treated with the composition exhibits no greater adhered kaolin residue than a surface treated with the control composition.

The word “polymer” includes homopolymers, copolymers and ter- and higher polymers.

A variety of film-forming agents may be used in the disclosed compositions and methods. The film-forming agent may for example be a viscous or solid heat-sensitive substance containing one or more high molecular weight hydrocarbons or fatty acid esters. The film-forming agent desirably provides a composition that can be hand- or machine-applied to a glossy surface and buffed, rubbed or otherwise formed into a thin, streak-free and smear-free glossy protective coating that is substantially insoluble in water and soluble in one or more common organic solvents. The composition desirably hardens merely by drying and without requiring the application of heat, UV or other external energy. Representative film-forming agents will be familiar to those skilled in the art and include animal waxes such as beeswax, spermaceti, Chinese insect, lanolin and shellac wax; vegetable waxes such as carnauba, candelilla, palm, bayberry, jojoba, sugarcane, rice-bran, flax, peat, Japan, ouricury wax; mineral waxes such as ozocerite, ceresin, montan, paraffin, microcrystalline and petrolatum wax; synthetic film-forming agents such as ethylenic polymers (e.g., polyethylene and polypropylene polymers and copolymers), acrylic polymers (e.g., acrylate polymers and copolymers), polyol ether-esters, and chlorinated naphthalenes; and microcrystallized, oxidized, or chemically modified derivatives thereof. Acrylic polymers and copolymers may be preferred in some applications, and it may also be preferred that the composition be substantially free of natural waxes or that it be substantially free of synthetic waxes. Mixtures of film-forming agents may be employed. The film-forming agent may for example be about 0.01 to about 10 wt. %, about 0.1 to about 5 wt. % or about 1 to about 3 wt. % of the total composition weight.

A variety of solvents may be used in the disclosed compositions and methods. The solvent desirably facilitates spreading the disclosed composition onto a glossy surface without damaging the surface including any paint thereon. The solvent may also help dissolve and remove road tar, dried insects and other residues that may be present on the surface when the disclosed composition is applied, thereby helping to clean the surface. The solvent desirably evaporates quickly after the composition has been applied but does not contribute objectionable types or amounts of regulated volatile organic compounds (VOCs) into the atmosphere. Representative solvents will be familiar to those skilled in the art and may be an organic material such as a linear, branched, aliphatic, or aralkyl hydrocarbon liquid (e.g., mineral spirits, naphtha, Stoddard solvent, kerosene or dipentene); a cycloaliphatic hydrocarbon; an aromatic hydrocarbon (e.g., naphtha, toluene or xylene); or a terpene (e.g., pine oil or turpentine). Mixtures of solvents may be employed. The solvent may for example be about 1 to about 30 wt. %, about 5 to about 20 wt. % or about 10 to about 15 wt. % of the total composition weight.

A variety of fluoropolymers may be used in the disclosed compositions and methods. When a control composition containing an aqueous emulsion of the film-forming agent and solvent but no fluoropolymer is compared to an otherwise similar composition that also contains the fluoropolymer and evaluated using the kaolin clay particle retention test shown below in Example 1, a surface treated with the composition containing the fluoropolymer exhibits less adhered kaolin residue than a surface treated with the control composition. Also, when a glossy (e.g., painted, unwaxed) surface that has not been treated with any composition is compared to a surface that has been treated with a composition containing the fluoropolymer and evaluated using the water drop contact angle test shown below in Example 1, the surface treated with the composition containing the fluoropolymer exhibits a higher water contact angle than the untreated surface. Suitable fluoropolymers include REPELLAN™ NFC fluorinated polyacrylate (from Cognis Corp.), DRYFILM™ WDL10A antistick coating and DRYFILM RA/IPA polytetrafluoroethylene dispersion (both from DuPont Coating and Release Systems) and MEGATRAN™ 260F fluoro-acrylic copolymer (from Interpolymer Corp.). Mixtures of fluoropolymers may be employed. Sufficient fluoropolymer should be employed so that water will bead up on a surface treated with the disclosed composition. A desired amount will depend in part on the chosen fluoropolymer and its structure. As a general guide, the fluoropolymer may for example be about 1 to about 50 wt. %, about 2 to about 40 wt. % or about 5 to about 30 wt. % of the total composition weight.

The disclosed compositions contain water and may be in the form of water in oil emulsions or oil in water emulsions. The water may for example be distilled, deionized, softened or tap water. Water may for example be about 30 to about 97 wt. %, about 50 to about 80 wt. % or about 55 to about 70 wt. % of the total composition weight.

The disclosed compositions may contain an emulsifying agent to help form the recited emulsion. Representative emulsifying agents will be familiar to those skilled in the art and include amide, ester alcohol and amine surfactants. Mixtures of emulsifying agents may be employed. The emulsifying agent may for example be about 0.01 to about 10 wt. %, about 0.1 to about 5 wt. % or about 1 to about 3 wt. % of the total composition weight.

The disclosed compositions may contain a drying agent to promote more rapid drying. Representative drying agents will be familiar to those skilled in the art and include aluminum silicate clays. Mixtures of drying agents may be employed. The drying agent may for example be about 1 to about 25 wt. %, about 3 to about 15 wt. % or about 5 to about 10 wt. % of the total composition weight.

The disclosed compositions may contain a thickener or antisettling agent to control storage and flow properties. Representative antisettling agents will be familiar to those skilled in the art and include clays such as bentonite or hectorite clays. Mixtures of antisettling agents may be employed. The antisettling agent may for example be about 0.01 to about 10 wt. %, about 0.02 to about 5 wt. % or about 0.5 to about 3 wt. % of the total composition weight.

The disclosed compositions may contain a pH modifier to buffer the composition or change its acidity or basicity. Representative pH modifiers will be familiar to those skilled in the art and include organic and inorganic acids and bases. Mixtures of pH modifiers may be employed. The pH modifier may for example be about 0.01 to about 10 wt. %, about 0.02 to about 5 wt. % or about 0.5 to about 1 wt. % of the total composition weight.

The disclosed compositions may contain one or more abrasives to aid in removing oxidation or other damage in the treated surface. Suitable abrasives will be familiar to those skilled in the art and include diatomaceous earth, Fuller's earth, hydrated calcium silicate, alumina, aluminum silicate, various clays (e.g., bentonite and colloidal clay), Tripoli, amorphous silica, microcrystalline silica, pumice, garnet, chalk, magnesium oxide, red iron oxide and tin oxide.

The disclosed composition may contain other adjuvants that will be familiar to those skilled in the art. Representative adjuvants include biocides and other preservatives, chelants, defoamers, dyes, pigments, indicators, fragrances, thixotropes, lubricants, ultraviolet light protectants and absorbants, antioxidants, corrosion inhibitors, leveling agents and wetting agents. The types and amounts of such adjuvants will be apparent to those skilled in the art.

The disclosed compositions may be manufactured by mixing the ingredients in any convenient order. The physical form of the composition may include liquids, pastes, gels and foams. The disclosed compositions may be packaged in any convenient form including cans, bottles, drums, dispensers intended to be held by a user during product application and dispensers intended to be replaceably installed in a mixing or dispensing device. The composition may also be part of a kit including the composition and at least one of an applicator, microfiber towel or car wash detergent. These and other suitable packaging configurations will be familiar to those skilled in the art. The disclosed compositions may be applied by several methods including liquid spray, aerosol, rubbed-on or dispensed in a water stream. These and other methods by which the disclosed compositions may be applied, dried and polished to a suitably glossy state will be familiar to those skilled in the art. The disclosed compositions may be applied to a variety of vehicles including automobiles, trucks, buses, motorcycles, snowmobiles, all terrain vehicles, boats, aircraft and other vehicles used for recreation or transportation. The disclosed compositions may be applied to painted or glossy (e.g., molded plastic or gel-coated) surfaces including automotive trim, moldings, bumpers and interior panels including dashboards and door panels. The disclosed composition may be applied to metal surfaces including car rims and bumpers. The disclosed compositions may also be applied to wood finishes including those on furniture and floors, and to architectural surfaces including mineral surface coatings, porcelain, ceramic and glass.

The invention is further illustrated in the following non-limiting examples, in which all parts and percentages are by weight unless otherwise indicated.

### EXAMPLE 1

### Impact of Various Ingredients on Automotive Clear Coat Soil Retention

The car wax formulation shown below in Table 1 was mixed in a high shear mixture to form an emulsion and then applied to one painted half of an automotive clear coat finish coated on 13 steel coupons.

TABLE 1

| Ingredient | Parts |
|---|---|
| Isoparaffinic hydrocarbon¹ | 13.95 |
| Synthetic isoparaffinic hydrocarbon² | 8.18 |
| Bentonite clay (thickener)³ | 0.40 |
| Tall oil fatty acid diethanolamide⁴ | 0.98 |
| Aminoalkoxydimethylpolysiloxane⁵ | 0.20 |
| Aminoalkoxydimethylsiloxane⁶ | 1.26 |
| Poly(dimethylsiloxane) fluid, 350 centistokes⁷ | 2.93 |
| Calcined kaolin⁸ | 9.73 |
| Water (zeolite softened) | 60.89 |
| Perfluorinated polyether fluid⁹ | 0.10 |
| 5-Chloro-2-methyl-3-isothiazoline-3-one¹⁰ (biocide) | 0.10 |
| 2-Amino-2-methyl-1-propanol¹¹ (dispersant) | 0.15 |
| Carnauba wax emulsion¹² | 0.98 |
| Amyl acetate¹³ | 0.15 |

¹ISOPAR ™ K (ExxonMobil Chemical.).
²ISOPAR M (ExxonMobil Chemical.).
³BENTONE ™ 34 (Elementis Specialties.).
⁴WITCAMIDE ™ 511 (Englehard Corp.).
⁵DC 536 Fluid (Dow Corning Corp.).
⁶DC 531 Fluid (Dow Corning Corp.).
⁷Dow 200 Fluid (Dow Corning Corp.).
⁸SATINTONE ™ 5 (Englehard Corp.).
⁹FOMBLIN ™ C (Solvay Solexis).
¹⁰KATHON ™ CG (Rohm and Haas Co.).
¹¹AMP-95 ™ (Angus Chemical).
¹²Carnauba C-340 Emulsion (Tomah Products, Inc.).
¹³Primary amyl acetate, mixed isomers (Dow Chemical Co.).

A modified formulation was prepared by removing the isoparaffinic hydrocarbons from the Table 1 formulation. Twelve additional modified formulations were prepared by individually removing each of the other ingredients from the Table 1 formulation. Each modified formulation was mixed and applied to the other painted half of a coupon so that each modified formulation could be compared side-by-side to the unmodified formulation. The coupons were dried and buffed, then dusted with kaolin clay. Each coupon was tapped to remove loose clay and evaluated visually to determine whether the amount of residual clay retained by the modified formulation was less than (“<”), the same as (“=”) or more than (“>”) the amount retained by the unmodified formulation. The coupons were next rinsed with water, dried in an oven at 120° C. for 5 minutes, and visually evaluated to determine whether the amount of residual clay retained after drying the modified formulation was less than, the same as or more than the amount retained after drying the unmodified formulation. Set out below in Table 2 are the 13 modified formulations, the removed ingredient in each modified formulation, and the observed results:

TABLE 2

| Modified | | Pre-Rinse | Post-Rinse |
|---|---|---|---|
| Formulation | | Kaolin | Kaolin |
| No. | Removed Ingredient(s) | Adhesion | Adhesion |
| 2-1 | isoparaffinic hydrocarbons | = | = |
| 2-2 | Bentonite clay (thickener) | = | = |
| 2-3 | Tall oil fatty acid diethanolamide | = | = |
| 2-4 | Aminoalkoxydimethylpolysiloxane | = | = |
| 2-5 | Aminoalkoxydimethylsiloxane | < | < |
| 2-6 | Poly(dimethylsiloxane) fluid | = | < |
| 2-7 | Calcined kaolin | = | = |
| 2-8 | Water, Zeolite Softened | = | < |
| 2-9 | Perfluorinated polyether fluid | = | < |
| 2-10 | 5-Chloro-2-methyl-3-isothiazoline- | = | = |
| | 3-one | | |
| 2-11 | 2-Amino-2-methyl-1-propanol | = | = |
| 2-12 | Carnauba wax emulsion | = | < |
| 2-13 | Amyl acetate | = | = |

The results in Table 2 show that several ingredients in the Table 1 car wax formulation may contribute to soil adhesion. Silicones including aminoalkoxydimethylsiloxane appeared to be especially prone to cause such soil adhesion.

The Table 1 car wax was next modified by adding small amounts of a 1:6 mixture of an amino-functional siloxane (DOW CORNING™ 531 Fluid, from Dow Corning Corp.) and an aminomethoxy-functional siloxane (DOW CORNING 536 Fluid, from Dow Coming Corp.). Concentrations as low as 0.5% of the mixed aminosilanes caused a noticeable increase in soil adhesion. This indicated that even nominal levels of silicone can affect dirt repellence properties.

The Table 1 formulation was next applied to one painted half of an automotive clear coat finish coated on 11 steel coupons. 100% (or where noted, 10%) solutions of various fluorinated polyacrylates, fluorinated phosphates, fluorinated silicones and fluorinated quaternary ammonium compounds were applied to the other painted half of a coupon so that each such material could be compared side-by-side to the unmodified formulation. The coupons were dried and buffed, then dusted with kaolin clay and evaluated as described above. Set out below in Table 3 are the 11 tested materials and the observed results:

TABLE 3

| | | Pre-Rinse | Post-Rinse |
|---|---|---|---|
| Material | | Kaolin | Kaolin |
| No. | Tested Material | Adhesion | Adhesion |
| 3-1 | Fluoroacrylate copolymer emulsion¹ | < | < |
| 3-2 | Fluoroacrylate copolymer emulsion² | < | < |
| 3-3 | Fluorinated phosphate surfactant³ | = | = |
| 3-4 | Ethoxylated nonionic fluorosurfactant⁴ | > | > |
| 3-5 | Fluorinated quaternary ammonium | = | = |
| | compound⁵ | | |
| 3-6 | Nonionic polymeric fluorochemical | > | < |
| | surfactant⁶ | | |
| 3-7 | Nonionic polymeric fluorochemical | > | < |
| | surfactant⁷ | | |
| 3-8 | Amphoteric acrylic copolymer⁸ | > | > |
| 3-9 | Liquid alkylfluorosilicone⁹ | > | > |
| 3-10 | Polydimethylsiloxane fluoropolymer¹⁰ | > | > |
| 3-11 | 3-glycidoxypropyltrimethoxysilane¹¹ | < | = |

¹REPELLAN NFC (Cognis Corp.).
²10% aqueous solution of REPELLAN NFC copolymer emulsion.
³ZONYL ™ FSJ (E.I. duPont de Nemours & Co.).
⁴ZONYL FSO (E.I. duPont de Nemours & Co.).
⁵LEDYNE ™ S106A (Ciba Specialty Chemicals).
⁶NOVEC ™ FC 4430 (3M).
⁷NOVEC FC 4432 (3M).
⁸POLYQUAT AMPHO ™ 149 (Cognis Corp.).
⁹FLUOROSIL ™ H418 (Siltech Corp.).
¹⁰SILWAX ™ F (Siltech. Corp.).
¹¹Z-6040 ™ (Dow Corning Corp.).

The results in Table 3 show that some fluorochemical materials could contribute to soil adhesion whereas other fluorochemical materials did not do so.

Next a base wax formulation was prepared from the ingredients shown below in Table 4 and 10 wt. % of each of the materials shown below in Table 5. The parts employed total more than 100:

TABLE 4

| Ingredient | Parts |
|---|---|
| Isoparaffinic hydrocarbon¹ | 13.95 |
| Synthetic isoparaffinic hydrocarbon² | 8.18 |
| Bentonite clay³ | 0.40 |
| Tall oil fatty acid diethanolamide⁴ | 0.98 |
| Calcined kaolin⁵ | 9.73 |
| Water (zeolite softened) | 60.89 |
| Perfluorinated polyether fluid | 0.10 |
| 5-Chloro-2-methyl-3-isothiazoline-3-one⁶ | 0.10 |
| 2-Amino-2-methyl-1-propanol⁷ | 0.15 |
| Carnauba wax emulsion | 0.98 |
| Amyl acetate | 0.15 |
| Material from Table 5 | 10.00 |

¹ISOPAR K (ExxonMobil Chemical.).
²ISOPAR M (ExxonMobil Chemical.).
³BENTONE 34 (Elementis Specialties.).
⁴WITCAMIDE 511 (Englehard Corp.).
⁵SATINTONE 5 (Englehard Corp.).
⁶KATHON CG (Rohm and Haas Co.).
⁷AMP-95 (Angus Chemical).

The resulting formulations were applied to an automotive clear coat finish coated on a steel coupon, dried and buffed. Using three repetitions, a water drop was placed on the treated surface and its contact angle measured using a goniometer. An untreated panel was also evaluated. Set out below in Table 5 are the tested materials and the observed average water drop contact angles:

TABLE 5

| | | Average |
|---|---|---|
| | | Water Drop |
| | | Contact |
| Material | | Angle |
| No. | Material | (degrees) |
| 5-1 | Fluoroacrylic polymer¹ | 76 |
| 5-2 | Fluorochemical dispersion² | 75 |
| 5-3 | Fluoroacrylate copolymer emulsion³ | 72 |
| 5-4 | Polytetrafluoroethylene dispersion⁴ | 69 |
| 5-5 | None | 61 |
| 5-6 | Liquid alkylfluorosilicone⁵ | 55 |
| 5-7 | Fluorochemical emulsion release coating⁶ | 54 |
| 5-8 | Fluorochemical emulsion release coating⁷ | 49 |
| 5-9 | Fluorinated phosphate surfactant⁸ | 44 |
| 5-10 | Fluorinated quaternary ammonium compound⁹ | 43 |
| 5-11 | Nonionic polymeric fluorochemical surfactant¹⁰ | 12 |
| 5-12 | Nonionic polymeric fluorochemical surfactant¹¹ | 8 |
| 5-13 | Ethoxylated nonionic fluorosurfactant¹² | 5 |

¹MEGATRAN 260F (Interpolymer Corp.).
²Dry Film WDL10A (DuPont Coating & Release Systems).
³REPELLAN NFC (Cognis Corp.).
⁴Dry Film RA/IPA (DuPont Coating & Release Systems).
⁵FLUOROSIL H418 (Siltech Corp.).
⁶RA-110W (Mayzo Inc.).
⁷RA-120W (Mayzo Inc.).
⁸ZONYL FSJ (E.I. duPont de Nemours & Co.).
⁹LEDYNE S106A (Ciba Specialty Chemicals).
¹⁰NOVEC FC 4430 (3M).
¹¹NOVEC FC 4432 (3M).
¹²ZONYL FSO (E.I. duPont de Nemours & Co.).

The results in Table 5 show that formulations containing fluorochemical materials 5-1 through 5-4 provided a higher water drop contact angle (corresponding to better water beading behavior on a treated surface). Formulations containing fluorochemical materials 5-6 through 5-13 provided a lower water drop contact angle (corresponding to a greater tendency for water to sheet out) than was observed on an untreated surface.

### EXAMPLE 2

### Car Wax Road Tests

An experimental car wax formulation was prepared by mixing the ingredients shown below in Table 6 in a high shear mixture to form an emulsion:

TABLE 6

| Ingredient | Parts |
|---|---|
| Isoparaffinic hydrocarbon¹ | 13.95 |
| Synthetic isoparaffinic hydrocarbon² | 8.18 |
| Bentonite clay³ | 0.40 |
| Tall oil fatty acid diethanolamide⁴ | 1.00 |
| Calcined kaolin⁵ | 8.00 |
| Water (zeolite softened) | 55.07 |
| Perfluorinated polyether fluid | 0.20 |
| Hindered amine⁶ | 1.00 |
| Acrylic acid copolymers⁷ | 2.00 |
| Fluoroacrylate copolymer emulsion⁸ | 10.00 |
| 5-Chloro-2-methyl-3-isothiazoline-3-one⁹ | 0.10 |
| 2-Amino-2-methyl-1-propanol¹⁰ | 0.10 |

¹ISOPAR K (ExxonMobil Chemical.).
²ISOPAR M (ExxonMobil Chemical.).
³BENTONE 34 (Elementis Specialties.).
⁴WITCAMIDE 511 (Englehard Corp.).
⁵SATINTONE 5 (Englehard Corp.).
⁶TINUVIN 5050 (Ciba Specialty Chemicals).
⁷POLIGEN ™ ES 91010 (BASF Corp.).
⁸REPELLAN ™ NFC (Cognis Corp.).
⁹KATHON ™ CG (Rohm and Haas Co.).
¹⁰AMP-95 (Angus Chemical).

The formulation in Table 6 was similar to the Table 1 formulation but without silicones, with substitution of an acrylic acid copolymer for the carnauba wax emulsion, and with the addition of 10 wt. % of the fluoroacrylate copolymer emulsion shown in Table 3 as Material 3-1. The driver's side of the hood on a dark blue JEEP™ Cherokee sport utility vehicle was treated with the Table 6 formulation and the passenger's side was treated with the Table 1 formulation. The hood was dusted with kaolin clay. The vehicle was driven 4 miles at a maximum speed of 70 mph, allowing excess clay to disperse. The vehicle was brought to a stop and photographed so that the residual clay on each side could be evaluated visually. Considerably less clay soil was retained on the driver's side of the hood, and the surface remained glossy. The passenger's side had a fine dusting of adhered soil, and was not glossy. The Table 6 formulation accordingly reduced the extent to which clay soil was attracted to a conventional clear coat finish.

The passenger's side of the hood of a white 1988 OLDSMOBILE™ 98 automobile was treated with the Table 6 formulation and the driver's side was treated with the Table 1 formulation. The automobile was driven down a dirt road behind another vehicle and allowed to accumulate significant quantities of road dust, then driven on a paved road at a maximum speed of 70 mph allowing the excess road dust to disperse. Adhesion of residual road dust on each side was evaluated by dragging a black cloth over each side for a distance of 30.5 cm under a 340 g weight. Considerably less road dirt was retained on the passenger's side of the hood. The Table 6 formulation accordingly reduced the extent to which road dirt was attracted to a conventional clear coat finish.

### EXAMPLE 3

Using the method of Example 1, two car wax formulations were prepared by mixing the ingredients shown below in Table 7 in a high shear mixture to form an emulsion:

TABLE 7

| | Formula | Formula |
|---|---|---|
| | 7-1, | 7-2, |
| Ingredient | Parts | Parts |
| Isoparaffinic hydrocarbon¹ | 13.95 | 13.95 |
| Synthetic isoparaffinic hydrocarbon² | 8.18 | 8.18 |
| Bentonite clay³ | 0.40 | 0.40 |
| Tall oil fatty acid diethanolamide⁴ | 1.00 | 1.00 |
| Calcined kaolin⁵ | 8.00 | 8.00 |
| Water (zeolite softened) | 61.17 | 56.07 |
| Perfluorinated polyether fluid | 0.20 | 0.20 |
| Acrylic acid copolymers⁶ | 1.00 | |
| Acrylic acid copolymers⁷ | 1.00 | 2.00 |
| Fluoroacrylate copolymer emulsion⁸ | 5.00 | 10.00 |
| 2-Amino-2-methyl-1-propanol⁹ | 0.10 | 0.10 |

¹ISOPAR ™ K (ExxonMobil Chemical.).
²ISOPAR M (ExxonMobil Chemical.).
³BENTONE ™ 34 (Elementis Specialties.).
⁴WITCAMIDE ™ 511 (Englehard Corp.).
⁵SATINTONE ™ 5 (Englehard Corp.).
⁶POLIGEN ™ ES-91009 (BASF Corp.).
⁷POLIGEN ES 91010 (BASF Corp.).
⁸REPELLAN ™ NFC (Cognis Corp.).
⁹AMP-95 (Angus Chemical).

Formulas 7-1 and 7-2 were applied to one painted half of an automotive clear coat finish coated on steel coupons. The Table 1 formulation was applied to the other painted half of a coupon so that Formulas 7-1 and 7-2 could be compared side-by-side to the unmodified formulation. The coupons were dried and buffed, then dusted with kaolin clay and evaluated as described in Example 1. Significantly less kaolin adhered to Formulas 7-1 and 7-2 than adhered to the Table 1 unmodified formulation.

The above described comparison was repeated by masking half of each coated coupon with aluminum foil perpendicular to the applied control coatings, dusting with kaolin clay and tapping to remove the loose clay. This provided a T₀ soil retention data point for each of Formulas 7-1 and 7-2. The coupons were then stored at 71° C. for 18 hours. After cooling to ambient temperature, the T₀ portion of each coupon was masked with foil, the original foil masks were removed and the thus-exposed portions were dusted with kaolin clay and tapped to remove loose clay. This provided a T_{18 hr} soil retention data point for each of Formulas 7-1 and 7-2. Residual clay retention on the T₀ and T_{18 hr} portions was evaluated visually. No increase in soil retention was noted for Formulas 7-1 or 7-2 after exposure to heat.

### EXAMPLE 4

### Car Wash Testing

Sections of an automobile were coated with the silicone-containing car wax formulations shown below in Table 8.

TABLE 8

| | Formula | Formula |
|---|---|---|
| | 8-1, | 8-2, |
| Ingredient | Parts | Parts |
| Isoparaffinic hydrocarbon¹ | 13.95 | 13.95 |
| Synthetic isoparaffinic hydrocarbon² | 8.18 | 8.18 |
| Tall oil fatty acid diethanolamide³ | 0.98 | 0.98 |
| Aminoalkoxydimethylpolysiloxane⁴ | 0.20 | 0.20 |
| Aminoalkoxydimethylsiloxane⁵ | 1.20 | 1.26 |
| Poly(dimethylsiloxane) fluid, 350 centistokes⁶ | 1.50 | 2.93 |
| Poly(dimethylsiloxane) fluid, 10,000 centistokes⁷ | 1.50 | |
| Bentonite clay⁸ | 0.40 | 0.40 |
| Calcined kaolin⁹ | 8.00 | 8.00 |
| Water (zeolite softened) | 58.74 | 58.75 |
| Perfluorinated polyether fluid¹⁰ | 0.10 | 0.10 |
| Polyethylene wax emulsion¹¹ | 5.00 | 5.00 |
| 5-Chloro-2-methyl-3-isothiazoline-3-one¹² | 0.10 | 0.10 |
| 2-Amino-2-methyl-1-propanol¹³ | 0.15 | 0.15 |

¹ISOPAR ™ K (ExxonMobil Chemical.).
²ISOPAR M (ExxonMobil Chemical.).
³WITCAMIDE ™ 511 (Englehard Corp.).
⁴DC 536 Fluid (Dow Corning Corp.).
⁵DC 531 Fluid (Dow Corning Corp.).
⁶DC 200 Fluid, 350 centistokes (Dow Corning Corp.).
⁷DC 200 Fluid, 10,000 centistokes (Dow Corning Corp.).
⁸BENTONE ™ 34 (Elementis Specialties.).
⁹SATINTONE ™ 5 (Englehard Corp.).
¹⁰FOMBLIN C (Solvay Solexis).
¹¹POLIGEN WE1 (BASF Corp.).
¹²KATHON ™ CG (Rohm and Haas Co.).
¹³AMP-95 (Angus Chemical).

Initial gloss data was taken for each treated section and averaged. The automobile was then subjected to daily automatic car wash cycles and gloss data was measured after each cycle. After 20 cycles the observed gloss for both formulations remained at more than 98% of the initially observed gloss value, indicating that gloss did not significantly decrease when the automobile was not allowed an opportunity to become dirty between washes.

Sections of the automobile were next coated with the silicone-containing car wax formulations shown below in Table 9 and with the Table 1 formulation:

TABLE 9

| | Formula | Formula | Formula |
|---|---|---|---|
| | 9-1, | 9-2, | 9-3, |
| Ingredient | Parts | Parts | Parts |
| Isoparaffinic hydrocarbon¹ | 13.95 | 13.95 | 13.95 |
| Synthetic isoparaffinic hydrocarbon² | 8.18 | 8.18 | 8.18 |
| Bentonite clay (thickener)³ | 0.40 | 0.40 | 0.40 |
| Tall oil fatty acid diethanolamide⁴ | 1.00 | 1.00 | 1.00 |
| Aminoalkoxydimethylpolysiloxane⁵ | 0.20 | 0.20 | 0.20 |
| Aminoalkoxydimethylsiloxane⁶ | 1.20 | 1.20 | 1.20 |
| Poly(dimethylsiloxane) fluid, | 1.50 | 1.50 | 1.50 |
| 350 centistokes⁷ | | | |
| Poly(dimethylsiloxane) fluid, | 1.50 | 1.50 | 1.50 |
| 10,000 centistokes⁸ | | | |
| Calcined kaolin⁹ | 8.00 | 8.00 | 8.00 |
| Water (zeolite softened) | 45.97 | 48.37 | 53.37 |
| Perfluorinated polyether fluid¹⁰ | 0.10 | 0.10 | 0.10 |
| Hindered amine¹¹ | 2.00 | | |
| 5-Chloro-2-methyl-3-isothiazoline-3-one¹² | 0.10 | 0.10 | 0.10 |
| Acrylic polymer¹³ | 0.80 | 0.40 | 0.40 |
| 2-Amino-2-methyl-1-propanol¹⁴ | 0.10 | 0.10 | 0.10 |
| Polyethylene wax emulsion¹⁵ | 10.00 | 10.00 | 10.00 |
| Hydrophobic polymer¹⁶ | 5.00 | 5.00 | |

¹ISOPAR ™ K (ExxonMobil Chemical.).
²ISOPAR M (ExxonMobil Chemical.).
³BENTONE ™ 34 (Elementis Specialties.).
⁴WITCAMIDE ™ 511 (Englehard Corp.).
⁵DC 536 Fluid (Dow Corning Corp.).
⁶DC 531 Fluid (Dow Corning Corp.).
⁷DC 200 Fluid, 350 centistokes (Dow Corning Corp.).
⁸DC 200 Fluid, 10,000 centistokes (Dow Corning Corp.).
⁹SATINTONE ™ 5 (Englehard Corp.).
¹⁰FOMBLIN C (Solvay Solexis).
¹¹TINUVIN 5050 (Ciba Specialty Chemicals).
¹²KATHON ™ CG (Rohm and Haas Co.).
¹³REPELLAN ™ NFC (Cognis Corp.).
¹⁴AMP-95 (Angus Chemical).
¹⁵POLIGEN ™ WE-1 (BASF Corp.)
¹⁶MINCOR ™ S-300 (BASF Corp.).

Initial gloss data was taken on each waxed section of the automobile and averaged. The automobile was then sprayed with a 0.4% solution of kaolin clay which was allowed to dry, followed by an automatic car wash cycle and gloss readings on each section. This was repeated 9 times. A steady decrease in gloss was noted, with the Table 1 formulation reaching 95% of the initially observed gloss value and Formula 9-3 reaching 97% of the initially observed gloss value. Formula 9-1 and Formula 9-2 provided intermediate results, with Formula 9-1 about 95.5% of the initially observed gloss value and Formula 9-2 reaching about 96% of the initially observed gloss value. These results indicated that a fundamental mechanism of gloss degradation is the cumulative deposition and apparent adhesion of minute particles of soil over many wash cycles.

Various modifications and alterations of this invention will be apparent to those skilled in the art without departing from this invention. It should therefor be understood that this invention is not limited to the illustrative embodiments set forth above.

We claim:

1. A glossy protective coating composition comprising a substantially silicone-free aqueous emulsion of a film-forming agent, solvent, and a fluoropolymer that reduces soil adhesion on and increases water repellency of surfaces treated with the glossy protective coating.

2. A composition according to claim 1 that contains no silicones.

3. A composition according to claim 1 that is substantially free of waxes.

4. A composition according to claim 1 wherein the film-forming agent comprises an animal wax, vegetable wax or mineral wax.

5. A composition according to claim 1 wherein the film-forming agent comprises an ethylenic polymer.

6. A composition according to claim 1 wherein the film-forming agent comprises an acrylic polymer.

7. A composition according to claim 1 wherein the film-forming agent comprises about 0.01 to about 10 wt. % of the total composition weight.

8. A composition according to claim 1 wherein the solvent comprises a linear, branched, aliphatic, or aralkyl hydrocarbon liquid; a cycloaliphatic hydrocarbon; an aromatic hydrocarbon or a terpene.

9. A composition according to claim 1 wherein the solvent comprises about 1 to about 30 wt. % of the total composition weight.

10. A composition according to claim 1 wherein the fluoropolymer comprises a fluorinated polyacrylate.

11. A composition according to claim 1 wherein the fluoropolymer comprises a polytetrafluoroethylene dispersion.

12. A composition according to claim 1 wherein the fluoropolymer comprises about 1 to about 50 wt. % of the total composition weight.

13. A composition according to claim 1 further comprising an emulsifying agent at about 0.01 to about 10 wt. % of the total composition weight.

14. A composition according to claim 1 further comprising a drying agent at about 1 to about 25 wt. % of the total composition weight and an antisettling agent at about 0.01 to about 10 wt. % of the total composition weight.

15. A method for protecting a painted or glossy surface comprising applying to the surface and drying a substantially silicone-free aqueous emulsion of a film-forming agent, solvent, and a fluoropolymer that reduces soil adhesion on and increases water repellency of the surface.

16. A method according to claim 15 further comprising buffing, rubbing or otherwise forming the dried emulsion into a thin, streak-free and smear-free glossy protective coating that is substantially insoluble in water.

17. A method according to claim 16 wherein kaolin clay soil does not adhere sufficiently so that the coating loses its gloss.

18. A method according to claim 15 wherein the emulsion contains no silicones.

19. A method according to claim 15 wherein the emulsion is substantially free of waxes.

20. A method according to claim 15 wherein the film-forming agent comprises an animal wax, vegetable wax or mineral wax.

21. A method according to claim 15 wherein the film-forming agent comprises an ethylenic polymer.

22. A method according to claim 15 wherein the film-forming agent comprises an acrylic polymer.

23. A method according to claim 15 wherein the film-forming agent comprises about 0.01 to about 10 wt. % of the total emulsion weight.

24. A method according to claim 15 wherein the solvent comprises a linear, branched, aliphatic, or aralkyl hydrocarbon liquid; a cycloaliphatic hydrocarbon; an aromatic hydrocarbon or a terpene.

25. A method according to claim 15 wherein the solvent comprises about 1 to about 30 wt. % of the total emulsion weight.

26. A method according to claim 15 wherein the fluoropolymer comprises a fluorinated polyacrylate.

27. A method according to claim 15 wherein the fluoropolymer comprises polytetrafluoroethylene.

28. A method according to claim 15 wherein the fluoropolymer comprises about 1 to about 50 wt. % of the total emulsion weight.

29. A method according to claim 15 wherein the emulsion further comprises an emulsifying agent at about 0.01 to about 10 wt. % of the total emulsion weight.

30. A method according to claim 15 wherein the emulsion further comprises a drying agent at about 1 to about 25 wt. % of the total emulsion weight and an antisettling agent at about 0.01 to about 10 wt. % of the total emulsion weight.
